(19) United States
(12) Patent Application Publication
(10) Pub. No.: US 2026/0080272 A1
(43) Pub. Date: Mar. 19, 2026

(54) PREDICTIVE MODEL TO EVALUATE PROCESSING TIME IMPACTS

(71) Applicant: AMGEN INC., Thousand Oaks, CA (US)

(72) Inventors: Luis Felipe Padilla, Thousand Oaks, CA (US); Pedro Marin-Hernandez, Thousand Oaks, CA (US)

(21) Appl. No.: 19/107,369

(22) PCT Filed: Aug. 28, 2023
(86) PCT No.: PCT/US2023/031217

§ 371 Date: Feb. 27, 2025

Related U.S. Application Data
(60) Provisional application No. 63/373,850, filed on Aug. 29, 2022.

(51) Int. Cl. G06N 5/022

(52) U.S. Cl. CPC G06N 5/022

(57) ABSTRACT

Systems and methods for evaluating impacts of processing time of a process (such as a bioprocess) can include (a) obtaining a model trained using historical bioprocess data, (b) determining, by applying input to the model, predicted output that would result when operating the bioprocess in accordance with the input, wherein either: (i) the input includes a processing time and the predicted output includes a product quality, or (ii) the input includes a product quality parameter and the predicted output includes a processing time, and (c) displaying or storing the values of the predicted output. Further aspects include receiving the input as user input from a user. Still further aspects include presenting the predicted output to the user via a graphical user interface.

### FIELD OF THE DISCLOSURE

The present application relates generally to the use of predictive models to evaluate the impacts of processing time, including processing time delays, on product quality.

### BACKGROUND

Biomolecules such as proteins, peptides, and nucleic acids are widely used as treatments for several diseases and play an important role in drug discovery. Typically, during the production of products including biomolecules, the product is exposed to steps with unforgiving chemical conditions that might compromise product stability. These steps may include pool conditioning steps as well as viral inactivation and clarification steps that require exposing the product to significant changes in the pool pH, conductivity, and/or temperatures, which are not favorable to biomolecules (e.g., reduce stability of the biomolecules). Accordingly, the product quality of the biomolecules produced using these types of steps may be sensitive to the length of time required to perform these steps. Furthermore, any operational delays that increase processing time during these steps will mean additional exposure of the product to these unforgiving chemical conditions that may be detrimental to the quality of the product.

One bioprocess in which processing time may have an effect on the product quality of the corresponding biomolecules is chromatography. Chromatography may be used to purify biomolecules by separating the biomolecules from a compound using one or more steps of separation based on specific physical, chemical, or biological features of the compound and biomolecules. For example, size, charge, hydrophobicity, function, or content of a given biomolecule may be used to isolate the given biomolecule. For commercial manufacturing purification, chromatography is typically carried out as column chromatography due to scale considerations. An example of a conventional column chromatography process 200 is illustrated in FIG. 2. As illustrated in the process 200, a loaded sample is first injected into a column. Mobile phase (eluent) is then pumped through the column, causing molecules of the loaded sample to separate based on their relative affinity for the stationary phase (stationary resin) and the mobile phase. Molecules of the loaded sample that are more strongly attracted to the stationary phase move more slowly through the system as compared to those that are more weakly attracted to the stationary phase. Different molecules will elute from the column at different times and after different volumes of mobile phase have passed through the column allowing therapeutic proteins to be separated from other substances that elute from a column at different times.

Other common types of chromatography include hydrophobic interaction chromatography, affinity chromatography, or Protein A chromatography. Still other types of chromatography include ion exchange chromatography (IEX), including anion exchange chromatography (AEX) and/or cation exchange chromatography (CEX), hydrophobic interaction chromatography (HIC), mixed modal or multimodal chromatography (MM), hydroxyapatite chromatography (HA), or reverse-phase chromatography. Other chromatography methods include expanded bed adsorption chromatography, simulated moving-bed chromatography, countercurrent chromatography (CCC), hydrodynamic countercurrent chromatography, or periodic countercurrent chromatography. Other types of chromatography include gel filtration, planar chromatography (e.g., paper chromatography, thin-layer chromatography), displacement chromatography, liquid chromatography, affinity chromatography (e.g., supercritical fluid chromatography), hydrodynamic chromatography, two dimensional chromatography, pyrolysis gas chromatography, fast protein liquid chromatography, chiral chromatography, centrifugal partition chromatography, or aqueous normal-phase chromatography.

Conventionally, when performing chromatography for purifying biomolecules, the parameters of the chromatography (e.g., elution buffer pH, elution buffer conductivity, elution buffer molarity, gradient slope, linear velocity, load, and collection times), and how the purification operation will perform for a particular product/molecule (e.g., with a particular solution, at a particular pH, etc.) are carefully determined. However, conventional chromatography processes (as well as other types of bioprocesses) conventionally do not account for unexpected changes in processing times due to delays (e.g., due to equipment malfunctions).

Moreover, optimal processing times can vary between manufacturing operations, and therefore can be difficult to anticipate. Failing to account for unexpected delays, or for process-specific variations in optimal processing times, when producing biomolecules can cause a greater ratio of the produced biomolecules to fail rigorous quality control measures for product quality that may be imposed by a regulatory entity, such as a governmental entity (e.g., the Food and Drug Administration), and with which the biomolecule must adhere. If a biomolecule does not meet specification limits of product quality, the biomolecule may be unusable. Furthermore, as the relationship between processing time and product quality is typically specific to individual manufacturing operations, failure to account for variations in processing time can also reduce transferability of production of a biomolecule between different bioprocess systems.

Accordingly, with conventional processes for producing molecules (e.g., chromatography), there is an increased likelihood that biomolecules will not conform with regulatory limits. The increased failure or reject rate may in turn correspond to increased cost in terms of time, labor, and other resources.

### BRIEF SUMMARY

Aspects of the present disclosure provide a method for evaluating impacts of processing time of a process (e.g., a bioprocess) including: (a) obtaining a model trained using historical bioprocess data including: (i) historical processing times of a plurality of instances of the bioprocess and (ii) corresponding historical product quality of products produced by the plurality of instances of the bioprocess; (b) determining, by applying input to the model, predicted output that would result when operating the bioprocess in accordance with the input, wherein either: (i) the input includes a processing time and the predicted output includes a product quality, or (ii) the input includes a product quality parameter and the predicted output includes a processing time; and (c) displaying or storing the predicted output.

In some aspects, the method further includes receiving the input as user input from a user. In some aspects, the method further includes presenting the predicted output to a user via a graphical user interface.

In some aspects, the processing time corresponds to one or both of: (i) an elapsed time of at least one step of the bioprocess, or (ii) an elapsed time between at least two steps of the bioprocess. In some aspects, the processing time corresponds to one or both of: (i) a delay time of at least one step of the bioprocess, or (ii) a delay time between at least two steps of the bioprocess.

In some aspects, the model is a linear regression model. In some aspects, the bioprocess is a chromatography process. In some aspects, the product is one or both of a drug or therapy and includes one or more of: a protein, a carbohydrate, a lipid, or a nucleic acid.

In some aspects, the predicted product quality parameter is a measure of one or more of: yield, viable cell density (VCD), titer, concentration, or a measure of a distance of a parameter of the new instance of the product to a specification limit. In some aspects, the bioprocess has a negative correlation between a given processing time and a given product quality.

Another aspect of the present disclosure provides a system including, (a) one or more processors; and (b) one or more non-transitory, computer-readable media storing instructions that, when executed by the one or more processors, cause the one or more processors to perform the method of any one of the previous aspects.

### BRIEF DESCRIPTION OF THE DRAWINGS

The skilled artisan will understand that the figures described herein are included for purposes of illustration and are not limiting on the present disclosure. The drawings are not necessarily to scale, emphasis instead being placed upon illustrating the principles of the present disclosure. It is to be understood that, in some instances, various aspects of the described implementations may be shown exaggerated or enlarged to facilitate an understanding of the described implementations. In the drawings, like primary characters throughout the various drawings generally refer to functionally similar or structurally similar components.

FIG. 1 is a simplified block diagram of an example system for evaluating impacts of processing time of a process (e.g., a bioprocess).

FIG. 2 depicts an example of a conventional column chromatography process.

FIG. 3 depicts an example process of applying a model to a bioprocess manufacturing operation to predict a product quality parameter based on an observed process delay.

FIG. 4A depicts an example graphical display displaying exemplary historical bioprocess data.

FIG. 4B depicts an example graphical display displaying an exemplary input interface.

FIG. 4C depicts an example graphical display displaying exemplary experimental performance data.

FIGS. 5A and 5B are flow diagrams depicting example methods for evaluating impacts of processing time of a process (e.g., a bioprocess).

### DETAILED DESCRIPTION

As the pace of biotechnology quickens, there is an increased emphasis placed on processing additional molecules in bioprocess pipelines, and thus an increasing need to more quickly design and implement steps of the manufacturing processes, such as chromatographic purification processes. The present disclosure aims to reduce problems with conventional techniques (e.g., as described in the Background section) by providing techniques for evaluating impacts of processing time of a process (e.g., a bioprocess). The present techniques may apply values of a processing time or a product quality parameters as inputs to a model in order to determine values of a predicted product quality parameter or a predicted processing time, respectively. By determining, and then displaying or storing, values of predicted processing time or the predicted product quality, the techniques aim to provide insight to an operator of the bioprocess system, decreasing the amount of biomolecules produced which do not satisfy quality conditions and increasing transferability of biomolecule production between different bioprocess systems.

Advantageously, by providing improved insights, the present techniques may provide insights into the effects of processing time (e.g., delay times) when designing a bioprocess or bioprocess system for producing a biomolecule. One advantage of these insights is that less resources (e.g., biomolecules) are wasted while calibrating the bioprocess system, and, accordingly, resource efficiency is increased and sustainability of the bioprocess system is improved. By making the bioprocess system more sustainable with respect to resource use, energy efficiency of the bioprocess system may also be improved and the financial or economic cost of producing each biomolecule may also be reduced. Another advantage of the improved insights is that production throughput may increase as more biomolecules can be produced in a given amount of time with lower calibration time. Furthermore, resource, energy, and cost efficiency may also be improved when dealing with unexpected delays in a bioprocess as present techniques provide insight into the usability (e.g., based on product quality) of the biomolecules produced under the delay conditions.

Additional advantages of the present techniques over conventional approaches of operating a bioprocess will be appreciated throughout this disclosure by one having ordinary skill in the art. The various concepts and techniques introduced above and discussed in greater detail below may be implemented in any of numerous ways, and the described concepts are not limited to any particular manner of implementation. Examples of implementations are provided below for illustrative purposes.

### Exemplary System

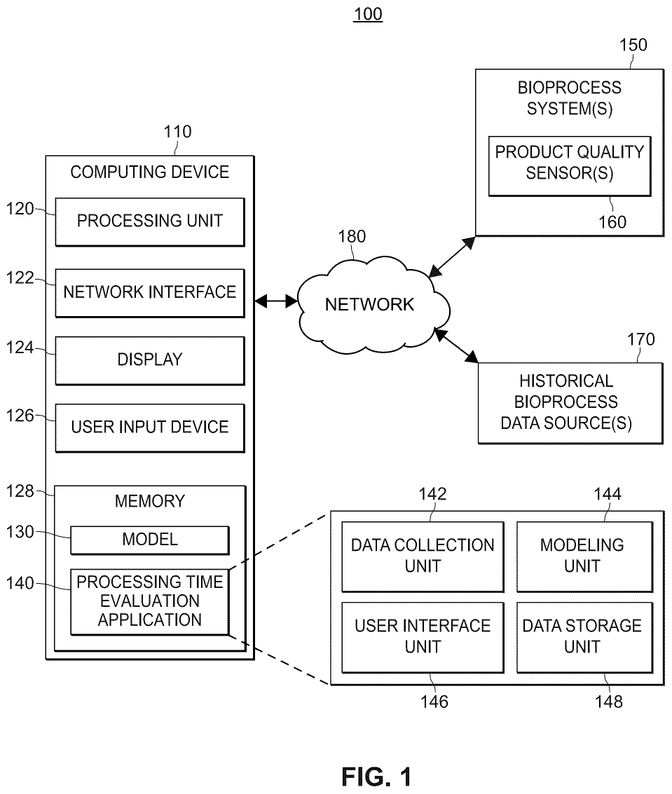

FIG. 1 is a simplified block diagram of an example system 100 for evaluating impacts of processing time of one or more bioprocess systems 150 for producing biomolecules which, for example, may be included in a drug product. In some aspects, the system 100 may include standalone equipment, though in other examples the system 100 may be incorporated into other equipment. At a high level, the system 100 includes components of a computing device 110, the bioprocess systems 150, one or more product quality sensors 160, and one or more historical bioprocess data sources 170. In FIG. 1, the computing device 110, the bioprocess systems 150, and the historical bioprocess data sources 170 are communicatively coupled via a network 180, which may be or include a proprietary network, a secure public internet, a virtual private network, or any other type of suitable wired and/or wireless network(s) (e.g., dedicated access lines, satellite links, cellular data networks, combinations of these, etc.). In embodiments where the network 180 comprises the Internet, data communications may take place over the network 180 via an Internet communication protocol. In some aspects, more or fewer instances of the various components of the system 100 than are shown in FIG. 1 may be included in the system 100 (e.g., one instance of the computing device 110, ten instances of the bioprocess systems 150, ten instances of the product quality sensors 160, two instances of the historical bioprocess data sources 170, etc.).

It is worth noting that while the system 100 is illustrated as including the bioprocess systems 150, one of ordinary skill in the art will understand that the present techniques and components of the system 100 may be applied to evaluating the effect of processing time (e.g., delay time) on other processes. For example, instead of the bioprocess systems 150, the present techniques and components of the system 100 may be applied to manufacturing of small molecule drug products.

The bioprocess systems 150 may include a single bioprocess system, or multiple bioprocess systems that are either co-located or remote from each other and are suitable for producing biomolecules. Biomolecules may be any of carbohydrates, lipids, nucleic acids, or proteins that are produced by cells and living organisms. Biomolecules have a wide range of sizes and structures and perform many functions. Bioprocesses that may produce a given biomolecule may isolate the biomolecule from cells which have produced the biomolecule through processes which include one (and often more) of: filtration, extraction, crystallization, membrane, and chromatography. The bioprocess systems 150 may generally include physical devices configured for use in producing (e.g., manufacturing) biomolecules.

The bioprocess systems 150 may, in some embodiments, be connected with the computing device 110 either via the network 180, or directly, allowing for at least some of the functionality of the bioprocess systems 150 to be controlled by the computing device 110. In some embodiments, the bioprocess systems 150 may be capable of receiving instruction directly from a user (e.g., the bioprocess systems 150 may be manually-configurable). For example, in some embodiments, the bioprocess systems 150 may receive instructions directly from a user to control operation (e.g., processing time for one or more steps of a chromatography process of the bioprocess systems 150 may be set to operate according to input from a user).

The product quality sensors 160 may be included in the bioprocess systems 150 (e.g., integrated into the bioprocess systems 150) or may be external sensors connected to the bioprocess systems 150. The product quality sensors 160 may be used to collect product quality parameter data (e.g., directly or indirectly) of biomolecules produced by the bioprocess systems 150. The product quality parameter may be a purity of the output of the bioprocess systems 150, which may be measured as a peak or peak purity (e.g., main peak CEX). The product quality sensors 160 may provide the product quality parameter data to, for example, the computing device 110 (e.g., via the network 180). The product quality parameter data may be any suitable data type, such as nominal data, ordinal data, discrete data, or continuous data. The product quality parameter data may be in the form of a suitable data structure, which may be stored in a suitable format such as of one or more of: JSON, XML, CSV, etc. The product quality parameter data may be collected or provided automatically, or in response to a request. For example, a user of the computing device 110 may wish to evaluate impacts of processing time of a bioprocess using the bioprocess systems 150. In response, one or more of the product quality sensors 160 may collect and provide the product quality parameter data to the computing device 110. In some embodiments, one or more of the product quality sensors 160 may include databases of data/information relating to product quality or may be configured to receive data/information relating to product quality, such as via user input.

The bioprocess systems 150 may include one or more devices (not shown) used in chromatography (e.g., one or more of the types of chromatography discussed in the Background Section). For example, the bioprocess systems 150 may include one or more of: columns, capillary tubes, plates, sheets, frits, flow cells, pumps, vacuums, detectors, collectors, injectors, etc. for performing chromatography. In other embodiments, the bioprocess systems also, or instead, include other equipment, such as a bioreactor, an outlet filter, etc.

The bioprocess systems 150 may be configured to be controllable via manual or automated inputs. In some embodiments, the bioprocess systems 150 may be configured to receive such control inputs locally, such as via a user input device local to the bioprocess systems 150. In some embodiments, the bioprocess systems 150 are configured to receive control inputs remotely, such as from the computing device 110 (e.g., via the network 180). The control inputs may include operation instructions, such as processing times according to which the bioprocess systems 150 should operate.

The historical bioprocess data sources 170 generally include historical bioprocess data that may correspond to one or more bioprocesses for producing one or more biomolecules using the bioprocess systems 150. The historical bioprocess data may include: (i) historical processing times of a plurality of instances of the bioprocess and (ii) corresponding historical product quality of products produced by those instances of the bioprocess. In some embodiments or scenarios, at least a portion of the historical bioprocess data is collected using the bioprocess systems 150. In some embodiments or scenarios, however, all of the historical bioprocess data is collected using different bioprocess systems. The historical bioprocess data may include data from bioprocesses that had scales/sizes, settings/parameters, equipment models, etc., similar to the bioprocess system(s) 150, and/or data from bioprocesses that had scales/sizes, settings/parameters, equipment models, etc., different from the bioprocess system(s) 150. In some embodiments, the system 100 may omit the historical bioprocess data sources 170, and instead receive the historical bioprocess data locally, such as via user input at the computing device 110.

The computing device 110 may include a single computing device, or multiple computing devices that are either co-located or remote from each other. The computing device 110 is generally configured to apply input to a model 130 trained using historical bioprocess data to determine a predicted output that would result when operating a bioprocess in accordance with the input, wherein either: (i) the input includes a processing time and the predicted output includes a product quality, or (ii) the input includes a product quality parameter and the predicted output includes a processing time. Components of the computing device 110 may be interconnected via an address/data bus or other means. The components included in the computing device 110 may include a processing unit 120, a network interface 122, a display 124, a user input device 126, and a memory 128, discussed in further detail below.

The processing unit 120 includes one or more processors, each of which may be a programmable microprocessor that executes software instructions stored in the memory 128 to execute some or all of the functions of the computing device 110 as described herein. Alternatively, one or more of the processors in the processing unit 120 may be other types of processors (e.g., application-specific integrated circuits (ASICs), field-programmable gate arrays (FPGAs), etc.).

The network interface 122 may include any suitable hardware (e.g., front-end transmitter and receiver hardware), firmware, or software configured to use one or more communication protocols to communicate with external devices or systems (e.g., the product quality sensors 160, the bioprocess systems 150, the historical bioprocess data sources 170, etc.) via the network 180. For example, the network interface 122 may be or include an Ethernet interface.

The display 124 may use any suitable display technology (e.g., LED, OLED, LCD, etc.) to present information to a user, and the user input device 126 may be a keyboard or other suitable input device. In some aspects, the display 124 and the user input device 126 are integrated within a single device (e.g., a touchscreen display). Generally, the display 124 and the user input device 126 may combine to enable a user to interact with graphical user interfaces (GUIs) or other (e.g., text) user interfaces provided by the computing device 110 (e.g., for purposes such as displaying data/information such as a product quality parameter or processing time, or notifying users of equipment faults or other deficiencies, etc.).

The memory 128 includes one or more physical memory devices or units containing volatile or non-volatile memory, and may or may not include memories located in different computing devices of the computing device 110. Any suitable memory type or types may be used, such as read-only memory (ROM), solid-state drives (SSDs), hard disk drives (HDDs), etc. The memory 128 may store (i) the model 130, and (ii) instructions of one or more software applications included in a processing time evaluation (PTE) application 140 that can be executed by the processing unit 120. In the example system 100, the PTE application 140 includes a data collection unit 142, a modeling unit 144, a user interface unit 146, and a data storage unit 148. The units 142-148 may be distinct software components or modules of the PTE application 140, or may simply represent functionality of the PTE application 140 that is not necessarily divided among different components/modules. For example, in some embodiments, the data collection unit 142 and the user interface unit 146 are included in a single software module. Moreover, in some embodiments, the units 142-148 are distributed among multiple copies of the PTE application 140 (e.g., executing at different components in the computing device 110), or among different types of applications stored and executed at one or more devices of the computing device 110.

The model 130 may be any suitable model for evaluating impacts of processing time of a process (e.g., a bioprocess). In some embodiments, and as discussed further below, the model 130 may be trained using at least some of the system 100, or, in some embodiments, the model 130 may be pre-trained (i.e., trained prior to being obtained by the system 100). The model 130 may be trained using historical bioprocess data including (i) historical processing times of a plurality of instances of the bioprocess and (ii) corresponding historical product quality of products produced by the plurality of instances of the bioprocess. In some embodiments, the model 130 may include a statistical model that may be parametric, nonparametric, or semiparametric. One suitable example of a statistical model which may be included in the model 130 is a linear regression model. In other embodiments, the model 130 includes a machine learning model. For example, the model 130 may employ a neural network, such as a convolutional neural network or a deep learning neural network. Other examples of machine-learning models in the model 130 are models that use support vector machine (SVM) analysis, K-Nearest neighbor analysis, naïve Bayes analysis, clustering, reinforcement learning, or other machine-learning algorithms or techniques. Machine learning models included in the model 130 may identify and recognize patterns in training data in order to facilitate making predictions for new data.

The data collection unit 142 is generally configured to receive data. In some embodiments, the data collection unit 142 receives the historical bioprocess data (e.g., including historical processing times of a plurality of instances of the bioprocess and corresponding historical product quality of products produced by the plurality of instances of the bioprocess) of a bioprocess for producing a biomolecule. The data collection unit 142 may receive the historical bioprocess data via, for example, the historical bioprocess data sources 170, user input received via the user interface unit 146 with the user input device 126, or other suitable means. In some embodiments, the data collection unit 142 may receive one or more values of a product quality parameter via, for example, the product quality sensors 160, user input received via the user interface unit 146 with the user input device 126, or other suitable means. In some embodiments processing time sensors (not shown) may provide timing data to the data collection unit 142. In some embodiments, the computing device 110 may receive at, for example, the data collection unit 142 an indication that a bioprocess has begun and one or more components of the computing device 110 may locally monitor processing time.

The modeling unit 144 is generally configured to generate, train, or apply the model 130. The modeling unit 144 may train the model 130 using the historical bioprocess data which may be received from the historical bioprocess data sources 170. The modeling unit 144 may also apply the model 130 when evaluating impacts of processing time of a process (e.g., a bioprocess). More specifically, the modeling unit 144 may apply an input to the model 130 to determine predicted output that would result when operating the bioprocess in accordance with the input, wherein either: (i) the input includes a processing time and the predicted output includes a product quality, or (ii) the input includes a product quality parameter and the predicted output includes a processing time. In some embodiments, the model 130 may be trained by a device or system outside the system 100 and instead the modeling unit 144 only applies inputs to the model 130 and is not involved in training the model 130.

The user interface unit 146 is generally configured to receive user input. In one example, the user interface unit 146 may generate a user interface for presentation via the display 124, and receive, via the user interface and user input device 126, user input for historical bioprocess data to be used by the modeling unit 144 when training the model 130. In another example, the user interface unit 146 may receive, via a user interface and user input device 126, the input(s) to be used by the modeling unit 144 when applying the model 130 (e.g., a processing time of a stage of the bioprocess, or one or more desired product quality parameters for a product produced by the bioprocess). The user interface unit 146 may also be used to display information. For example, the user interface unit 146 may be used to display the predicted output (e.g. the processing time of the bioprocess or one or more product quality parameters of the product produced by the bioprocess).

The data storage unit 148 is generally configured to store the predicted output determined by the modeling unit 144 (e.g., processing time or product quality parameter(s)). The data storage unit 148 may store the predicted output in the memory 128, or in a different suitable memory (e.g., in an external database or on a computer system not shown). In some embodiments, the data storage unit 148 also stores other information, such as the model inputs that correspond to predicted model outputs.

The operation of each of the units 142-148 is described in further detail below, with reference to the operation of the system 100.

### Exemplary Bioprocess Manufacturing Operation Process

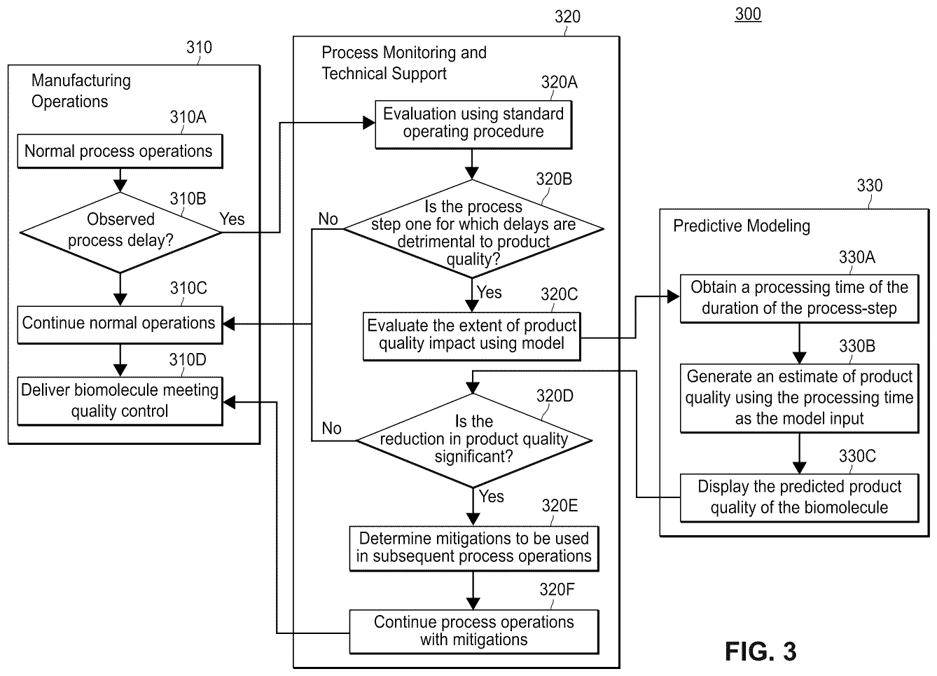

FIG. 3 depicts an example process 300 of applying a model to a bioprocess manufacturing operation to predict a product quality parameter based on an observed process delay. As illustrated, the process 300 includes manufacturing operations at a stage 310, process monitoring and technical support at a stage 320, and predictive modeling at a stage 330. The process 300 may be performed using equipment/apparatuses that may be the same as or similar to those discussed above in connection with the system 100. For example, the computing device 110 may implement (e.g., using data collected from the bioprocess systems 150) at least some of the process 300.

In one exemplary embodiment, the manufacturing operations of stage 310 of the process 300 begins at substage 310A, where the bioprocess is in normal process operation. The bioprocess may be operating according to parameters previously determined, either experimentally or through modeling, to result in biomolecules that are produced in accordance with quality control standards. Assuming no process delays are observed (e.g., by the operator of the bioprocess, or in an automated manner such as using the computing device 110 with the data collection unit 142) at substage 310B, the normal process operations may continue at substage 310C until the full amount of biomolecules which meet quality control standards are produced, with the complete process remaining in the stage 310 of manufacturing operations. However, if a process delay (due to, e.g., either avoidable or unavoidable causes) is observed (e.g., by the operator of the bioprocess, or in an automated manner such as using the computing device 110 with the data collection unit 142) at the substage 310B, the process 300 may move to the stage 320 of process monitoring and technical support.

The stage 320 may include monitoring and technical support of the bioprocess, using, for example, the computing device 110 to manage resolution of possible problems in the bioprocess. In some embodiments, the stage 320 begins with substage 320A of evaluating the observed process delay according to the standard operating procedure of the bioprocess. As discussed previously, certain process steps of a bioprocess may require exposing biomolecules mid-production to chemical conditions that may reduce their stability. For example, pool conditioning process steps, viral inactivation, and clarification process steps require exposing the product to significant changes in pool pH, conductivity, or temperature that are not favorable to the biomolecules. Therefore, for these process steps, there may be a negative correlation between the duration of the process step and the product quality parameter of the biomolecules produced. At the substage 320A, the standard operating procedure may be referenced (e.g., by the operator or by the computing system 110) to determine if the observed process delay occurs during a process step for which delays are detrimental to biomolecule product quality. If not, then the process 300 returns to the stage 310 for continuing normal operation of the bioprocess. However, if the observed process delay does correspond to a process step for which delays are detrimental to biomolecule product quality, then the process 300 continues to substage 320C to evaluate the extent of product quality impact using a model (e.g., the model 130 as applied by the modeling unit 144). Operation of the substage 320C requires advancing the process to the stage 330.

The stage 330 may include operating a trained model (e.g., the model 130) to determine a predicted product quality parameter based on the observed process delay. In some embodiments, the stage 330 may begin with substage 330A of obtaining a processing time of the duration of the process step (e.g., a total processing time including current or expected delay). As discussed previously, the process step may be a process step having a negative correlation between the duration of the process step and the product quality parameter of the biomolecules produced by the bioprocess. Therefore, the observed delay in the bioprocess could potentially cause a significant reduction in the product quality parameter of the biomolecule. At substage 330B, the model (e.g., the model 130 used by the modeling unit 144) receives the processing time as an input to estimate product quality parameter of the biomolecules. At substage 330C, the product quality parameter may be displayed (e.g., by a graphical user interface presented by the user interface unit 146 on the display 124). Once the product quality parameter is displayed at the substage 330C, the process 300 may return to the stage 320 of process monitoring and technical support.

Returning to the stage 320, at substage 320D it is decided whether the product quality parameter displayed at the substage 330C corresponds to a “significant” reduction in product quality. In some embodiments, the operator may make the decision at the substage 330D. In other embodiments, a computer system (e.g., the computing device 110) makes the decision. Deciding whether the reduction in the product quality parameter is “significant” may be based on certain guidelines or rules. For example, specification limits, which may be set by a manufacturer or a regulatory body, may be used to decide if the reduction in product quality parameter is “significant.” In another example, a threshold (e.g., if product quality parameter is reduced by a certain percentage) may be used to decide if the reduction in the product quality parameter is significant. If the reduction in the product quality parameter of the biomolecules with the observed process delay is not determined to be significant, then the process 300 returns to the stage 310 for continuing normal operation of the bioprocess. However, if the reduction in the product quality parameter of the biomolecules with the observed process delay is determined to be significant, then the process 300 continues to substage 320E to determine mitigations to be used in subsequent process operations.

In some embodiments, an example mitigation to be used in subsequent process operations of substage 320E may include changing processing time of one or more steps of the bioprocess. For example, the model (e.g., the model 130 used by the modeling unit 144) may be “run in reverse” of how the model is used in the stage 330. Specifically, the model may receive as input an acceptable product quality parameter (e.g., a product quality parameter just within specification limits) such that the model may predict a processing time for one or more steps of the bioprocess to achieve the acceptable product quality. In some embodiments, parameters of the bioprocess other than processing times may be adjusted. For example, when chromatography is the bioprocess, parameters such as elution buffer pH, elution buffer conductivity, elution buffer molarity, gradient slope, linear velocity, load, and collection times may be mitigations for adjusting the bioprocess to meet quality control. In some embodiments, subsequent process steps are adjusted to attempt to correct a biomolecule subjected to the delay. For example, if the delay results in the variable cell density of the biomolecule being too low, then an amount of nutrients at a later process step may be increased to compensate. In some embodiments, if mitigating the effects of the delay is not possible for biomolecules subjected to the delay, then the biomolecules may be discarded altogether. Provided mitigations exist and are feasible to implement,, the process 300 may advance to substage 320F of continuing process operations of the bioprocess, using the mitigations, and then to the substage 310D of delivering biomolecules which meet quality control.

### Exemplary Graphical Displays

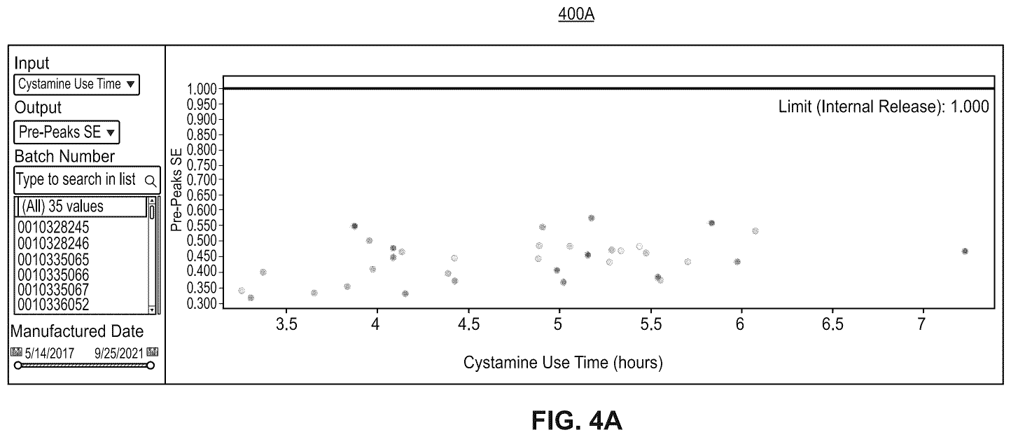

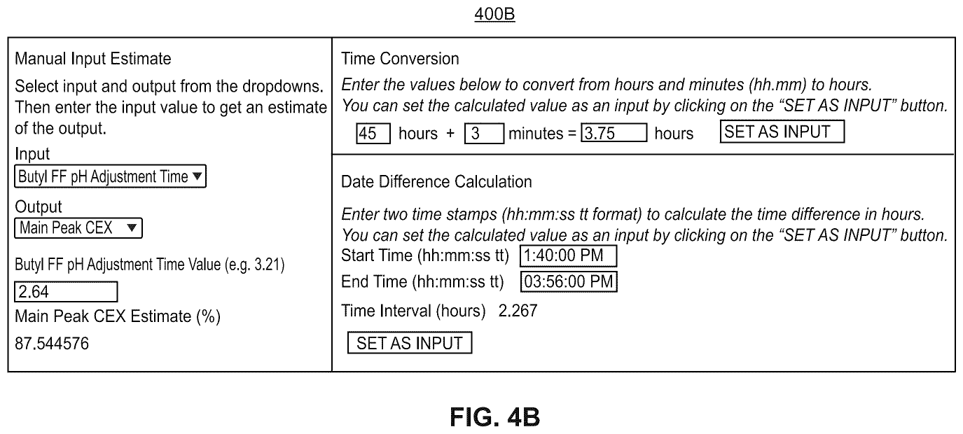

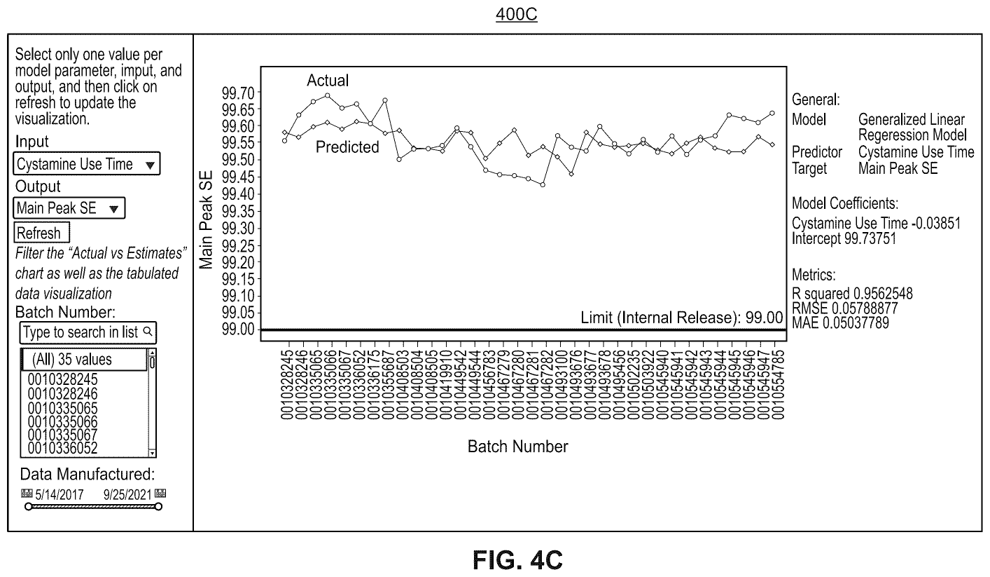

FIGS. 4A-C depict example graphical interfaces(s) 400A-400C that may be generated by the user interface unit 146 of FIG. 1. As illustrated, the interface 400A includes an exemplary graphical representation of historical bioprocess data of a bioprocess including (i) historical processing times for instances of the bioprocess and (ii) corresponding historical product quality of products produced by the instances of the bioprocess. As illustrated, the interface 400B includes an exemplary user interface for estimating output product quality parameters of biomolecules produced by the bioprocess based on an input processing time. As illustrated, the interface 400C includes an exemplary graphical representation comparing actual and predicted product qualities for the bioprocess, for a number of different processing times.

The user interface unit 146 may present the displays 400A-C on the display 124, in a single screen or multiple screens, and may receive inputs (e.g., the input processing time, an indication of file location(s) of the historical bioprocess data, the plurality of actual product qualities, etc.) via one or more of the user interfaces 400A-C and the user input device 126. The historical bioprocess data represented in the interface 400A may be provided, in some embodiments, by historical bioprocess data sources such as the historical bioprocess data sources 170. The modeling unit 144 may estimate the output product quality parameters represented in the interface 400B using the model 130. The actual product quality parameters represented in the interface 400C may be determined using product quality sensors such as the product quality sensors 160 of the bioprocess systems 150. The modeling unit 144 may predict the product qualities represented in the interface 400C may be determined using the model 130.

The historical bioprocess data of interface 400A may be filtered or modified based on different inputs, outputs, batch numbers, and manufacture dates that can be selected via user input. As illustrated, the product quality of the historical bioprocess data is measured as pre-peaks SE and the processing time of the historical bioprocess data is measured as a number of hours of cystamine use time. In certain bioprocesses, biomolecules may be exposed to the organic disulfide, cystamine. Cystamine is known to be an unstable liquid and possesses certain properties of toxicity, wherein, in some bioprocesses, an increased exposure time of a biomolecule to cystamine may be detrimental to the product quality parameter of the biomolecule. Therefore, it may be useful to assess the impact of cystamine use time on pre-peak SE for biomolecules. Pre-peak SE is a measure of product quality which may be used for size exclusion (SE) chromatography. A higher pre-peak SE score may indicate a more pure biomolecule which accordingly has a higher product quality.

The input processing time may be input (e.g., by a user) via the user interface 400B as a number of different processing times. As illustrated, the input processing time is 2.64 hours of Butyl FF pH Adjustment Time. Based on the input processing time, the model predicts the output product quality. As illustrated, the output product quality parameter is 87.544576% Main Peak CEX. While the input processing time is in units of hours of Butyl FF pH Adjustment Time and the output product quality parameter is in units of percentage Main Peak CEX, other possible units of the input processing time may be used, and other possible units of the output product quality parameters may be used. It is also worth noting, in some embodiments, the input may be an input product quality parameter and the output may be an output processing time. In some embodiments, if output targets (e.g., specification limits, warning limits, etc.) are provided, the interface 400B may indicate to a user if the output product quality parameter or the output processing time is within the output targets. As illustrated, the interface 400B also includes a Time Conversion and Date Difference Calculation tool to aid a user in determining a number of hours for the input processing time as a decimal. In some embodiments, the determined number of hours may be automatically entered as the input processing time for the model, or in response to a user selecting either “SET AS INPUT” button, as illustrated.

The interface 400C compares the actual and predicted product qualities (as measured in Main Peak CEX) for each batch of the historical bioprocess data of the interface 400A, based on a processing time (as measured in Cystamine Use Time) for each of the batches. As illustrated, the predicted product qualities are determined using a generalized linear regression model. The exemplary experimental performance data of the interface 400C has an R squared value over 0.95, a root-mean square error of about 0.058, and a mean absolute error of about 0.050. Accordingly, the exemplary performance data demonstrates the effectiveness of present techniques in developing a model for evaluating impacts of processing time of a process (e.g., a bioprocess), as the predicted product quality parameter closely tracks the actual product quality.

### Exemplary Flow Diagram

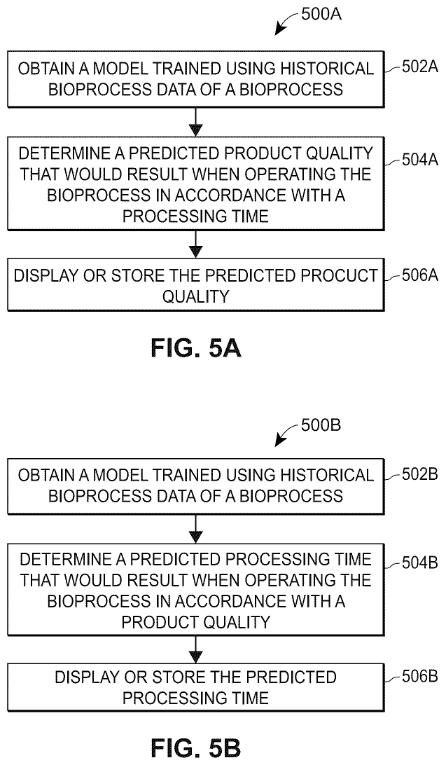

FIGS. 5A and 5B are flow diagrams respectively depicting example methods 500A and 500B for evaluating impacts of processing time of a process (e.g., a bioprocess). The methods 500A or 500B may be implemented by one or more components of the system 100, such as the processing unit 120 when implementing the PTE application 140 and possibly also the bioprocess systems 150 (which may be operating a bioprocess such as the column chromatography process 200). The method 500A or 500B may be performed as a part of a process that is the same as or similar to the process 300. The methods 500A or 500B may use historical bioprocess data (e.g., the historical bioprocess data represented in the interface 400A) and may receive input processing times or input product qualities (e.g., via the interface 400B) and display input/output processing times or input/output product qualities using one or more graphical displays which may be the same as or similar to the graphical displays of FIGS. 4A-4C.

The example method 500A may include the following elements: (1) obtaining a model trained using historical bioprocess data of a bioprocess (block 502A), (2) determining a predicted product quality parameter that would result when operating the bioprocess in accordance with a processing time (block 504A), and (3) displaying or storing the predicted product quality parameter (block 506A).

The trained model obtained at block 502A may have been trained using historical bioprocess data (e.g., as described above), such as the historical bioprocess data included in the historical bioprocess sources 170. In some embodiments, obtaining the model at block 502A includes receiving a pre-trained model (i.e., trained prior to being obtained by, for example, the system 100), or generating/training (e.g., by the system 100) the model. The model may be obtained internally (e.g., by accessing files/programs/data/information stored locally in a computing system, such as the computing device 110) or externally (e.g., by receiving the model from an outside source, such as receiving the model at the computing device 110 via the network 180). The product quality of the historical bioprocess data may be an indicator of purity of biomolecules produced by the bioprocess (e.g., measured as a peak or peak purity, such as main peak CEX), yield, viable cell density (VCD), titer, concentration, etc., or a measure of a difference between a product quality parameter and a specification limit, for example. The processing time of the historical bioprocess data may be a duration of one or more steps of the bioprocess (e.g., including any delays), or one or more delays in the bioprocess (e.g., the time above and beyond a desired amount of time).

Block 504A may include determining, by applying the processing time to the model, the predicted product quality parameter that would result when operating the bioprocess in accordance with the processing time. The processing time may be input by a user via a user interface (e.g., using the user input device 126) or by collecting the processing time as data (e.g., via the data collection unit 146). The predicted product quality parameter may be estimated to be either a single value, or a range of possible values by the model. In some embodiments, the model may determine if the predicted product quality parameter satisfies one or more conditions (e.g., thresholds, tolerances, specification limits, warning limits, etc.). In some embodiments, the model may be a linear regression model or some other suitable statistical model. In some embodiments, the model is a machine learning model such as a linear regressor, a random forest model, a neural network (e.g., a convolutional neural network, a deep learning neural network, etc.), a model using support vector machine (SVM) analysis, K-Nearest neighbor analysis, naïve Bayes analysis, clustering, or reinforcement learning, or another suitable machine learning model.

Block 506A may include displaying or storing, via a computing device such as the computing device 110, the predicted product quality. In some aspects the predicted product quality parameter itself may be displayed, while in other aspects a representation of the predicted product quality parameter may be displayed. Displaying the predicted product quality parameter may specifically use, for example, the display 124 and the user interface unit 146 of the computing device 110. In some embodiments, the predicted product quality parameter itself may be stored, while in other aspects a representation (e.g., a graphical representation or data visualization technique) of the first values of the predicted product quality parameter may be stored. The predicted product quality parameter be, for example, stored in the memory 128 of the computing device 110 using the data storage unit 148.

Turning to the example method 500B, the method 500B may include the following elements: (1) obtaining a model trained using historical bioprocess data of a bioprocess (block 502B), (2) determining a predicted processing time that would result when operating the bioprocess in accordance with a product quality parameter (block 504B), e.g., when operating the bioprocess in a manner that would achieve a desired product quality parameter, and (3) displaying or storing the predicted processing time (block 506B).

Block 502B may be the same as or similar to the block 502A and the model of 502B may be the same as or similar to the model of 502A. Block 504B may be the same as or similar to block 504A, but instead of the processing time serving as input to the model, the product quality parameter serves as input to the model and instead of the model predicting the product quality, the model predicts the processing time. Finally, block 506B may be the same as or similar to block 506A, but instead of displaying or storing the predicted product quality, the predicted processing time is displayed or stored.

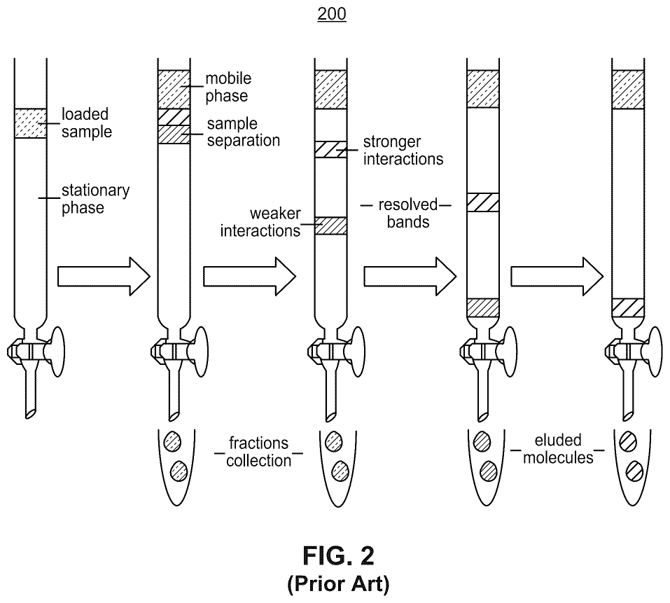

In some aspects, the methods 500A and 500B may be performed either entirely by automation, e.g., by one or more processors (e.g., a CPU or GPU) that execute instructions stored on one or more non-transitory, computer-readable storage media (e.g., a volatile memory or a non-volatile memory, a read-only memory, a random-access memory, a flash memory, an electronic erasable program read-only memory, or one or more other types of memory. The methods 500A and 500B may use any of the components, processes, or techniques of one or more of FIGS. 1-4.

### Additional Considerations

The term “process operation” or “unit operation” refer to a functional step that is performed as part of the process of purifying a recombinant protein of interest and are used interchangeably. For example, a process operation can include steps such as, but not limited to, harvest, chromatography (capture and polish), filtration, viral inactivation, virus filtration, concentration and/or formulation the product of interest.

Harvest operations clarify and/or purify the product away from at least one impurity with which it is found in the cell culture fluid, such as remaining cell culture media, cells and/or cell debris, undesired cell or media components, and/or product-and/or process-related impurities. Methods for harvesting include, but are not limited to, acid precipitation, accelerated sedimentation such as flocculation, separation using gravity, centrifugation, acoustic wave separation, filtration, including membrane filtration, ultrafilters, microfilters, tangential flow, alternative tangential flow, depth filters, and alluvial filtration filters.

Chromatography operations make use of media that captures and/or polishes the target product. Chromatography operations include single column systems, multicolumn column systems, such as periodic counter current culture and expanded bed chromatography systems, and the like. Chromatography media include monoliths, resins, and/or membranes containing agents that will bind and/or interact in some manner with at least one desired product, impurity, or contaminant. Chromatography media include those that make use of Staphylococcus proteins such as Protein A, Protein G, Protein A/G, and Protein L; substrate-binding capture mechanisms; antibody-or antibody fragment-binding capture mechanisms; aptamer-binding capture mechanisms; cofactor-binding capture mechanisms; immobilized metal affinity chromatography (IMAC), size exclusion chromatography, ion exchange chromatography (IEX) such as cation exchange (CEX) and anion exchange (AEX) chromatography, hydrophobic interaction chromatography (HIC), multimodal or mixed-modal (MMC), hydroxyapatite chromatography (HA), reverse phase chromatography and gel filtration, among others and the like. Such media are known in the art and are commercially available and include, but are not limited to, MABSELECT™ SURE Protein A, Protein A Sepharose FAST FLOW™, MABSELECT™ PrismA (Cytiva, Marborough, MA), PROSEP-A™ (Merck Millipore, U. K), TOYOPEARL™HC-650F Protein A (TosoHass Co., Philadelphia, PA), and AP Plus, Purolite, King of Prussia, PA), Capto™ Adhere, Capto™ MMC Impress, Capto MMC, (Cytiva), PPA Hypercel, MEP Hypercell, HEA Hypercell (Pall Corporation, Port Washington, NY). Eshmuno HCX, (Merk Millipore), Toyopearl MX-Trp-650M (Tosoh Bioscience), Phenyl Sephrose™ (Cytiva), Tosoh hexyl (Tosoh Bioscience), and Capto™ phenyl (Cytiva), CA++Pure-HA, Tosho Bioscience, HA ULTROGEL®, Sartorius), and the like.

Filtration operations are used to reduce and/or remove any resulting turbidity, precipitate, impurity, and/or contamination associated with the product. Filtration includes the use of depth filters, sterile and/or bioreduction control filters, ultrafilters, microfilters, tangential flow filters, alternative tangential flow filters, alluvial filters, and the like. Depth filters suitable for use in the methods are known in the art and are commercially available. Such filters include, but are not limited to, cellulose, pre-treated filtration matrix, synthetic fiber meshes or a combination all. In some embodiments, the filtration step is depth filtration or tangential flow filtration. Such filters are known in the art and commercially available and include, but are not limited to, VIRESOLVE® Pro Shield, VIRESOLVE® Pro Shield H, MILLISTAK+® DOHC filter, MILLISTAK+® XOHC filter, MILLISTAK+® COHC filter, MILLISTAK+® COSP filter, MILLISTAK+® XOSP filter, Clarisolve 20MS filter, Clarisolve 40MS filter, Clarisolve 60HX filter, (Millipore, Burlington, MA), SARTOCLEAR® DL60 filter, SARTOCLEAR® DL75 filter (Sartorius, Göttingen, Germany), 3M™ Zeta Plus™ Filter, diatomaceous earth, 3M™ Emphaze™ AEX Hybrid Purifier (EM, Meriden, CT), and the like. Sterile and/or bioreduction control filtration. Such filters are known in the art and commercially available and include, but are not limited to, Millipore EXPRESS® SHC hydrophilic polyetheresulfone filter (Millipore) and SARTOPORE® 2 polyethersulfone (PES) liquid filters (Sartorius).

Process operations directed towards inactivating, reducing and/or eliminating viral contaminants may include operations that mitigate viral risk by manipulating the environment and/or through use of filtration. Viruses are classified as enveloped and non-enveloped viruses. With enveloped viruses, the envelope allows the virus to identify, bind, enter, and infect target host cells. As such, enveloped viruses are susceptible to inactivation methods. Various methods can be employed for virus inactivation and include heat inactivation/pasteurization, UV and gamma ray irradiation, use of high intensity broad spectrum white light, addition of chemical inactivating agents, surfactants, and solvent/detergent treatments. Surfactants, such as detergents, solubilize membranes and therefore can be very effective in specifically inactivating enveloped viruses, and the like. Non-enveloped viruses are more difficult to inactivate without risk to the product purified and are removed by filtration methods. Viral filtration can be performed using micro-or nano-filters, such as those available from PLAVONA® (Asahi Kasei, Chicago, IL), VIROSART® (Sartorius, Goettingen, Germany), VIRESOLVE® Pro (MilliporeSigma, Burlington, MA), Pegasus™ Prime (Pall Biotech, Port Washington, NY), CUNO Zeta Plus VR, (3M, St. Paul, Mn), and the like.

Production operations may also comprise product concentration and formulation. One such operation makes use of ultrafiltration and diafiltration. Suitable materials known and common in the art and are commercially available from many sources including, regenerated cellulose Pellicon (MilliporeSigma, Danvers, MA), stabilized cellulose, Sartocon® Slice, Sartocon® ECO Hydrosart® (Sartorius, Goettingen, Germany), polyethersulfone (PES) membrane, Omega (Pall Corporation, Port Washington, NY) and the like.

Product quality includes physical, chemical, biological and/or microbial properties or characteristics for which appropriate limits or ranges have been determined to ensure desired product quality. Such attributes may be critical attributes such as specific productivity, pH, osmolality, appearance, color, aggregation, percent yield and titer, among others. Monitoring and measurements can be performed using known techniques and commercially available equipment.

The methods described herein can be used in association with production processes used to purify products of interest. The products can be of scientific or commercial interest, including protein-based therapeutics. Products of interest include, but are not limited to, secreted proteins, non secreted proteins, intracellular proteins, or membrane-bound proteins. Products of interest can be produced by recombinant animal cell lines using cell culture methods described herein and may be referred to as “recombinant proteins.” The expressed protein(s) may be produced intracellularly or secreted into the culture medium from which it can be recovered and/or collected. The products of interest are purified away from proteins or polypeptides or other contaminants that would interfere with the product's therapeutic, diagnostic, prophylactic, research, or other use. Products of interest include, but are not limited to, proteins that exert a therapeutic effect by binding one or more targets, such as, e.g., a target among those listed below, including targets derived therefrom, targets related thereto, and modifications thereof.

Proteins of interest may include, but are not limited to, “antigen-binding proteins.” An “antigen-binding protein” refers to a protein or polypeptide that comprises an antigen-binding region or antigen-binding portion that has affinity for another molecule to which it binds (antigen). Antigen-binding proteins include, but are not limited to, antibodies, peptibodies, antibody fragments, antibody derivatives, antibody analogs, fusion proteins (including, e.g., single chain variable fragments (scFvs), double-chain (divalent) scFvs, and IgGscFv (see, e.g., Orcutt et al., 2010, Protein Eng Des Sel 23:221-228)), hetero-IgG (see, e.g., Liu et al., 2015, J Biol Chem 290:7535-7562), bispecific antibodies, multispecific antibodies, muteins, XmAb® molecules (Xencor, Inc., Monrovia, CA) and the like. Also included are all forms of bispecific T cell engagers molecules. In addition chimeric antigen receptors (CARs, CAR Ts), and T cell receptors (TCRs) are included.

In some embodiments, products of interest may include colony stimulating factors, such as, e.g., granulocyte colony-stimulating factor (G-CSF). Such G-CSF agents include, but are not limited to, Neupogen® (filgrastim) and Neulasta® (pegfilgrastim). Also included are erythropoiesis stimulating agents (ESA), such as, e.g., Epogen® (epoetin alfa), Aranesp® (darbepoetin alfa), Dynepo® (epoetin delta), Mircera® (methyoxy polyethylene glycol-epoetin beta), Hematide®, MRK-2578, INS-22, Retacrit® (epoetin zeta), Neorecormon® (epoetin beta), Silapo® (epoetin zeta), Binocrit® (epoetin alfa), epoetin alfa Hexal, Abseamed® (epoetin alfa), Ratioepo® (epoetin theta), Eporatio® (epoetin theta), Biopoin® (epoetin theta), epoetin alfa, epoetin beta, epoetin zeta, epoetin theta, and epoetin delta, epoetin omega, epoetin iota, tissue plasminogen activator, and GLP-1 receptor agonists, as well as variants or analogs thereof and biosimilars of any of the foregoing.

In some embodiments, products of interest bind to one of more of the following, alone or in any combination: CD proteins including, but not limited to, CD3, CD4, CD5, CD7, CD8, CD19, CD20, CD22, CD25, CD30, CD33, CD34, CD38, CD40, CD70, CD123, CD133, CD138, CD171, and CD174, HER receptor family proteins, including, for instance, HER2, HER3, HER4, and the EGF receptor, EGFRvIII, cell adhesion molecules, for example, LFA-1, Mol, p150,95, VLA-4, ICAM-1, VCAM, and alpha v/beta 3 integrin, growth factors, including but not limited to, for example, vascular endothelial growth factor (“VEGF”); VEGFR2, growth hormone, thyroid stimulating hormone, follicle stimulating hormone, luteinizing hormone, growth hormone releasing factor, parathyroid hormone, mullerian-inhibiting substance, human macrophage inflammatory protein (MIP-1-alpha), erythropoietin (EPO), nerve growth factor, such as NGF-beta, platelet-derived growth factor (PDGF), fibroblast growth factors, including, for instance, aFGF and bFGF, epidermal growth factor (EGF), Cripto, transforming growth factors (TGF), including, among others, TGF-α and TGF-β, including TGF-β1, TGF-β2, TGF-β3, TGF-β4, or TGF-β5, insulin-like growth factors-I and-II (IGF-I and IGF-II), des(1-3)-IGF-I (brain IGF-I), and osteoinductive factors, insulins and insulin-related proteins, including, but not limited to, insulin, insulin A chain, insulin B-chain, proinsulin, and insulin-like growth factor binding proteins; (coagulation and coagulation-related proteins, such as, among others, factor VIII, tissue factor, von Willebrand factor, protein C, alpha-1-antitrypsin, plasminogen activators, such as urokinase and tissue plasminogen activator (“t-PA”), bombazine, thrombin, thrombopoietin, and thrombopoietin receptor, colony stimulating factors (CSFs), including the following, among others, M-CSF, GM-CSF, and G-CSF, other blood and serum proteins, including but not limited to albumin, IgE, and blood group antigens, receptors and receptor-associated proteins, including, for example, flk2/flt3 receptor, obesity (OB) receptor, growth hormone receptors, and T-cell receptors; neurotrophic factors, including but not limited to, bone-derived neurotrophic factor (BDNF) and neurotrophin-3, -4, -5, or -6 (NT-3, NT-4, NT-5, or NT-6); relaxin A-chain, relaxin B-chain, and prorelaxin, interferons, including for example, interferon-alpha, -beta, and -gamma, interleukins (ILs), e.g., IL-1 to IL-10, IL-12, IL-15, IL-17, IL-23, IL-12/IL-23, IL-2Ra, IL1-R1, IL-6 receptor, IL-4 receptor and/or IL-13 to the receptor, IL-13RA2, or IL-17 receptor, IL-1RAP; viral antigens, including but not limited to, an AIDS envelope viral antigen, lipoproteins, calcitonin, glucagon, atrial natriuretic factor, lung surfactant, tumor necrosis factor-alpha and-beta, enkephalinase, BCMA, IgKappa, ROR-1, ERBB2, mesothelin, RANTES (regulated on activation normally T-cell expressed and secreted), mouse gonadotropin-associated peptide, DNase, FR-alpha, inhibin, and activin, integrin, protein A or D, rheumatoid factors, immunotoxins, bone morphogenetic protein (BMP), superoxide dismutase, surface membrane proteins, decay accelerating factor (DAF), AIDS envelope, transport proteins, homing receptors, MIC (MIC-a, MIC-B), ULBP 1-6, EPCAM, addressins, regulatory proteins, immunoadhesins, antigen-binding proteins, somatropin, CTGF, CTLA4, eotaxin-1,MUC1, CEA, c-MET, Claudin-18, GPC-3, EPHA2, FPA, LMP1, MG7, NY-ESO-1, PSCA, ganglioside GD2, ganglioside GM2,BAFF, OPGL (RANKL), myostatin, Dickkopf-1 (DKK-1), Ang2, NGF, IGF-1 receptor, hepatocyte growth factor (HGF), TRAIL-R2, c-Kit, B7RP-1, PSMA, NKG2D-1, programmed cell death protein 1 and ligand, PD1 and PDL1, mannose receptor/hCGβ, hepatitis-C virus, mesothelin dsFv[PE38] conjugate, Legionella pneumophila (IIy), IFN gamma, interferon gamma induced protein 10 (IP10), IFNAR, TALL-1, thymic stromal lymphopoietin (TSLP), proprotein convertase subtilisin/Kexin Type 9 (PCSK9), stem cell factors, Flt-3, calcitonin gene-related peptide (CGRP), OX40L, α4β7, platelet specific (platelet glycoprotein IIb/IIIb (PAC-1), transforming growth factor beta (TFGβ), Zona pellucida sperm-binding protein 3 (ZP-3), TWEAK, platelet derived growth factor receptor alpha (PDGFRα), sclerostin, and biologically active fragments or variants of any of the foregoing.

In some embodiments, proteins of interest include abciximab, adalimumab, adecatumumab, aflibercept, alemtuzumab, alirocumab, anakinra, atacicept, basiliximab, belimumab, bevacizumab, biosozumab, blinatumomab, brentuximab vedotin, brodalumab, cantuzumab mertansine, canakinumab, cetuximab, certolizumab pegol, conatumumab, daclizumab, denosumab, eculizumab, edrecolomab, efalizumab, epratuzumab, etanercept, evolocumab, galiximab, ganitumab, gemtuzumab, golimumab, ibritumomab tiuxetan, infliximab, ipilimumab, lerdelimumab, lumiliximab, Ixdkizumab, mapatumumab, motesanib diphosphate, muromonab-CD3, natalizumab, nesiritide, nimotuzumab, nivolumab, ocrelizumab, ofatumumab, omalizumab, oprelvekin, palivizumab, panitumumab, pembrolizumab, pertuzumab, pexelizumab, ranibizumab, rilotumumab, rituximab, romiplostim, romosozumab, sargamostim, tocilizumab, tositumomab, trastuzumab, ustekinumab, vedolizumab, visilizumab, volociximab, zanolimumab, and zalutumumab, as well as biosimilars of any of the foregoing.

Some of the figures described herein illustrate example block diagrams having one or more functional components. It will be understood that such block diagrams are for illustrative purposes and the devices described and shown may have additional, fewer, or alternate components than those illustrated. Additionally, in various aspects, the components (as well as the functionality provided by the respective components) may be associated with or otherwise integrated as part of any suitable components.

Some aspects of the disclosure relate to a non-transitory computer-readable storage medium having instructions/computer-readable storage medium thereon for performing various computer-implemented operations. The term “instructions/computer-readable storage medium” is used herein to include any medium that is capable of storing or encoding a sequence of instructions or computer codes for performing the operations, methodologies, and techniques described herein. The media and computer code may be those specially designed and constructed for the purposes of the aspects of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as ASICs, programmable logic devices (“PLDs”), and ROM and RAM devices.

Examples of computer code include machine code, such as produced by a compiler, and files containing higher-level code that are executed by a computer using an interpreter or a compiler. For example, an aspect of the disclosure may be implemented using Java, C++, or other object-oriented programming language and development tools. Additional examples of computer code include encrypted code and compressed code. Moreover, an aspect of the disclosure may be downloaded as a computer program product, which may be transferred from a remote computer (e.g., a server computer) to a requesting computer (e.g., a computer or a different server computer) via a transmission channel. Another aspect of the disclosure may be implemented in hardwired circuitry in place of, or in combination with, machine-executable software instructions.

As used herein, the singular terms “a,” “an,” and “the” may include plural referents, unless the context clearly dictates otherwise. This description, and the claims that follow, should be read to include one or at least one and the singular also includes the plural unless expressly stated or it is obvious that it is meant otherwise. As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the terms “approximately,” “substantially,” “substantial,” “roughly” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the techniques disclosed herein have been described with primary to particular operations performed in a particular order, it will be understood that these operations may be combined, sub-divided, or re-ordered to form an equivalent technique without departing from the teachings of the present disclosure. Accordingly, unless specifically indicated herein, the order and grouping of the operations are not limitations of the present disclosure.

1. A method for evaluating impacts of processing time of a process, comprising:
obtaining, by one or more processors, a model trained using historical process data including (i) historical processing times of a plurality of instances of the process and (ii) corresponding historical product quality of products produced by the plurality of instances of the process;
determining, by the one or more processors applying input to the model, predicted output that would result when operating the process in accordance with the input,
wherein either: (i) the input includes a processing time and the predicted output includes a predicted product quality parameter, or (ii) the input includes a product quality parameter and the predicted output includes a predicted processing time; and
displaying or storing, by the one or more processors, the predicted output.

2. The method of claim 1, further comprising:
receiving, by the one or more processors, the input as user input from a user.

3. The method of claim 1, further comprising:
presenting, by the one or more processors, the predicted output to a user via a graphical user interface.

4. The method of claim 1, wherein one or both of the processing time or the predicted processing time each corresponds to one or both of: (i) an elapsed time of at least one step of the process, or (ii) an elapsed time between at least two steps of the process.

5. The method of claim 1, wherein one or both of the processing time or the predicted processing time each corresponds to one or both of: (i) a delay time of at least one step of the process, or (ii) a delay time between at least two steps of the process.

6. The method of claim 1, wherein the model is a linear regression model.

7. The method of claim 1, wherein the process is a bioprocess.

8. The method of claim 7, wherein the bioprocess is a chromatography process.

9. The method claim 1, wherein the product is one or both of a drug or therapy and includes one or more of: a protein, a carbohydrate, a lipid, or a nucleic acid.

10. The method of claim 1, wherein one or both of the product quality parameter or the predicted product quality parameter are each a measure of one or more of: yield, viable cell density (VCD), titer, concentration, or a measure of a distance of a parameter of a new instance of the product to a specification limit.

11. The method of claim 1, wherein the process has a negative correlation between a given processing time and a given product quality.

12. A system comprising:
one or more processors; and
one or more non-transitory, computer-readable media storing instructions that, when executed by the one or more processors, cause the one or more processors to:
obtain a model trained using historical process data including (i) historical processing times of a plurality of instances of the process and (ii) corresponding historical product quality parameter of products produced by the plurality of instances of the process;
determine, by applying input to the model, predicted output that would result when operating the process in accordance with the input,
wherein either: (i) the input includes a processing time and the predicted output includes a predicted product quality parameter, or (ii) the input includes a product quality parameter and the predicted output includes a predicted processing time; and
display or store the predicted output.

13. The system of claim 12, wherein the instructions further cause the one or more processors to:
receive the input as user input from a user.

14. The system of claim 12, wherein the instructions further cause the one or more processors to:
present the predicted output to a user via a graphical user interface.

15. The system of claim 12, wherein one or both of the processing time or the predicted processing time each corresponds to one or both of: (i) an elapsed time of at least one step of the process, or (ii) an elapsed time between at least two steps of the process.

16. The system of claim 12, wherein one or both of the processing time or the predicted processing time each corresponds to one or both of: (i) a delay time of at least one step of the process, or (ii) a delay time between at least two steps of the process.

17. The system of claim 12, wherein the model is a linear regression model.

18. The system of claim 12, wherein the process is a chromatography process.

19. The system of claim 12, wherein the product is one or both of a drug or therapy and includes one or more of: a protein, a carbohydrate, a lipid, or a nucleic acid.

20. The system of claim 12, wherein one or both of the product quality parameter or the predicted product quality parameter are each a measure of one or more of: yield, viable cell density (VCD), titer, concentration, or a measure of a distance of a parameter of a new instance of the product to a specification limit.

21. A method for determining the usability of a product that experienced an unexpected delay during purification, comprising:
purifying the product by one or more process operations;
experiencing delay conditions during a process operation;
taking a sample of the product following the unexpected delay;
subjecting the sample to a model trained using historical process data including:
(i) historical processing times of a plurality of instances of the process, and
(ii) corresponding historical product quality of products produced by the plurality of instances of the process;
determining a predicted output that would result when operating the process in accordance with an input, wherein either:
(i) the input includes a processing time and the predicted output includes a predicted product quality parameter, or
(ii) the input includes a product quality parameter and the predicted output includes a predicted processing time; and
using the predicted output to determine the usability of the product produced under the delay conditions.

22. The method of claim 21, wherein the process operation includes one or more of harvest, chromatography, filtration, viral inactivation, virus filtration, concentration and/or formulation.

23. The method of claim 21, wherein the usability is based on predicted product quality of the product produced under the delay conditions.

24. The method of claim 23, further comprising decreasing an amount of product produced which do not satisfy product quality parameters.
